(19) United States
(12) Patent Application Publication
(10) Pub. No.: US 2023/0158396 A1
(43) Pub. Date: May 25, 2023

(54) Arithmetic Game

(71) Applicant: William Morosky, Erie, PA (US)

(72) Inventor: William Morosky, Erie, PA (US)

(21) Appl. No.: 17/921,913

(22) PCT Filed: May 10, 2021
(86) PCT No.: PCT/US2021/031660

§ 371 Date: Oct. 27, 2022

Related U.S. Application Data
(60) Provisional application No. 63/022,434, filed on May 9, 2020.

(51) Int. Cl. A63F 3/04; A63F 9/00; A63F 1/04; A63F 3/00

(52) U.S. Cl. CPC A63F 3/0415; A63F 9/0098; A63F 1/04; A63F 3/00697; A63F 2001/0416; A63F 2003/00996; A63F 2003/00703

(57) ABSTRACT

An arithmetic game is played by selecting a target value that is an integer between 1 and 9. A field of initial integers is selected and subsequent fields of integers are generated by strategically selecting and combining integers from the field of initial integers or from another subsequent field of integers. At least one combined integer or at least one operated integer is added to, subtracted from, multiplied by, or divided by at least one other combined integer or at least one other operated integer to produce at least one sum, difference, product, or quotient that is a calculated integer. Subsequent fields of integers are created until a target field is created with no carried integers and the remaining calculated or combined integers are added, subtracted, multiplied, or divided to produce a sum, difference, product, or quotient that is the target value.

### SUMMARY OF THE INVENTION

An arithmetic game involves choosing digits that can be acted on arithmetically, combined, or manipulated to equal a sole integer or “target value.” The game is played by selecting a set of available arithmetical functions from addition, subtraction, multiplication, and division and selecting the target value that is an integer, most often between 1 and 9, but sometimes a larger positive value. A quantity of initial integers is selected and a field of the initial integers having the quantity of selected initial integers is generated randomly or purposefully, with all selected initial integers in the initial field being single digit integers.

Subsequent fields of integers are generated by selecting and combining into at least one combined integer at least two integers from the initial integer field or from another subsequent field of integers. Carried single digit integers are selected from the initial integer field or from said another subsequent field of integers. Integers that are all single digit integers and that have not been selected to be combined into at least one combined integer and have not been selected to be carried integers are selected from the initial integer field or from another subsequent field of integers. Using at least one function from the available set of available arithmetical functions, at least one combined integer or at least one operated integer is added to, subtracted from, multiplied by, or divided by at least one other combined integer or at least one other operated integer to produce at least one sum, difference, product, or quotient that is a calculated integer. The subsequent field of integers becomes all the digits of all the carried integers and all the digits of all the calculated integers.

After strategically creating one or more subsequent fields, a player can select one subsequent field to be a target field to generate a target value if the field has no carried integers. The player then strategically selects which of the integers of the target field are to be combined into combined integers and strategically selects which of the integers of the target field are to be operated integers. The player then uses at least one function from the available set of available arithmetical functions with at least one combined integer from the target field or at least one operated integer from the target field to add to, subtract from, multiply by, or divide by another combined integer from the target field or another operated integer from the target field to produce a sum, difference, product, or quotient that is the target value.

### BRIEF DESCRIPTION OF THE DRAWINGS

For a more complete understanding and appreciation of this invention, and its many advantages, reference will be made to the following Detailed Description of the Invention taken in conjunction with the accompanying drawings.

FIG. 1 is an example manipulation of initial, subsequent, and target fields of integers to arrive at a target value according to one embodiment game of the invention;

FIG. 2 is an example manipulation of initial, subsequent, and target fields of integers to arrive at a target value according to one embodiment game of the invention;

FIG. 4 is an example manipulation of initial, subsequent, and target fields of integers to arrive at a target value according to one embodiment game of the invention;

FIG. 5 is an example manipulation of initial, subsequent, and target fields of integers to arrive at a target value according to one embodiment game of the invention played with game chips;

FIG. 5A is an example manipulation of initial, subsequent, and target fields of integers to arrive at a target value according to one embodiment game of the invention played with playing pieces in a board game;

FIG. 6 is an example manipulation of initial, subsequent, and target fields of integers to arrive at a target value according to one embodiment game of the invention played with playing cards;

FIG. 7 is an example manipulation of initial, subsequent, and target fields of integers to arrive at a target value according to one embodiment game of the invention played with electronic avatars in a virtual environment;

FIG. 8 is an example manipulation of initial, subsequent, and target fields of integers to arrive at a target value according to one embodiment game of the invention;

FIG. 9 is an example manipulation of initial, subsequent, and target fields of integers to arrive at a target value according to one embodiment game of the invention;

FIG. 10 is an example manipulation of initial, subsequent, and target fields of integers to arrive at a target value according to one embodiment game of the invention;

FIG. 11 is an example manipulation of initial, subsequent, and target fields of integers to arrive at a target value according to one embodiment game of the invention; and

FIG. 12 is an example manipulation of initial, subsequent, and target fields of integers to arrive at a target value according to one embodiment game of the invention.

### DETAILED DESCRIPTION OF THE INVENTION

Referring to the drawings, some reference numerals are used to designate the same or corresponding elements through several of the embodiments and figures shown and described. Variations in corresponding elements are denoted in specific embodiments with the addition of lowercase letters. Subsequent variations in elements that are depicted in the figures but not described are intended to correspond to the specific embodiments mentioned earlier and are discussed to the extent that they vary in form or function. It will be understood generally that variations in the embodiments could be interchanged without deviating from the intended scope of the invention.

The arithmetic game of the invention involves choosing digits that are to be acted on arithmetically, combined, or manipulated to equal a sole integer or “target value.” The player selects the target value that is any integer between 1 and 9. Some contemplated embodiments of the invention allow the player to utilize an integer greater than 9. The player also selects a quantity of integers to be used for the initial field of integers. The quantity of integers chosen for the initial field can be less than, equal to, or greater than the target value. The player can also select which arithmetical functions among addition, subtraction, multiplication, and division will be available for use during the game.

The player then generates the selected quantity of integers for the initial field of integers. The integers of the initial field must all be single digit integers from 1 to 9, which can repeated or duplicated in the field, e.g. 4,4,4 or 4,4,7, and which can be purposefully chosen or generated randomly. It will be appreciated that the initial field of integers can be randomly generated using a random number generator, a spinwheel, dice, drawing numbers, or be simply chosen by the player or third parties, and that any random or purposeful generation technique is within the contemplated scope of the invention.

Once the initial field of integers is established, the player must then strategically arrange and then subject the integers to any of the chosen available arithmetical functions among addition, subtraction, multiplication, and division to create subsequent fields of integers to ultimately arrive at the target value. There are no limits on how many times an arithmetical function can be utilized nor is there any requirement a particular chosen arithmetical function ever be utilized. However, all arithmetical functions must equal an integer. No fractions are permitted in the initial or subsequent fields of integers. All integers in the initial and subsequent fields of integers must be used to ultimately arrive at the target value.

In playing, any two integers can be combined in any chosen order within a particular initial, subsequent, or target field of integers to create a combined integer. For example, 3 combined with 4=34 or 43. 4 combined with 9=49 or 94. 3 combined with 9=39 or 93. Any created double digit can be reversed, for example 34 to 43.

Any uncombined integer used in an arithmetic function in an initial or subsequent field of integers is an operated integer. Any unused integer is a carried integer. However, any combined integer must be utilized. If a single digit integer has been utilized and eliminated, the remaining double digit integer can be unlinked in the effort to equal a particular integer. For example, 43 can be unlinked to 4, 3 or 3, 4. Both of the remaining single digit integers can then be strategically used to reach the target value

A two digit and a single digit integer can be used to strategically reach the target value. A double digit integer can be acted on using one of the chosen arithmetical functions by the remaining operated integer. For example, 34−9=25. 43−9=34. 49−3=46. 94−3=91. Any unused carried integer is simply carried to the next subsequent field of integers.

If an arithmetic function is used to arrive at a two integer sum, difference, product, or quotient, the individual digits of the product can be flipped. For example, 21 can be flipped to 12.

The player continues to use the available arithmetical functions and manipulation of digits to create subsequent fields of integers, until a target field of integers is created having no carried integers which can be used to arrive at the target value using the remaining combined and operated integers.

In playing, value or scoring can be recorded based on any one or any combination of achievements, including the total number of possible strategic solutions, the number arithmetic functions utilized, how rapidly a target value is reached, first player to arrive at a target value, and how many solutions are discovered in a set period of time.

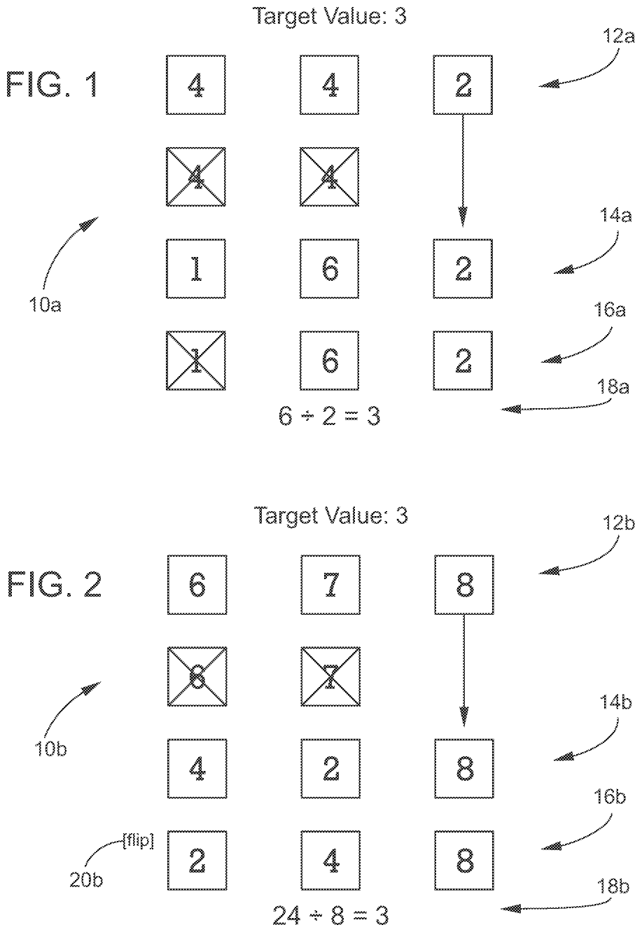

FIG. 1 depicts an example game 10a according to one contemplated embodiment of the invention having a selected target value of 3 and a selected quantity of 3 integers for the initial field 12a of integers of 4, 4, 2. Multiplication and division are selected as available arithmetical functions. The player selects 4 and 4 as operated integers and 2 as a carried integer, with 4×4=16. 4 and 4 are therefore eliminated as integers and the subsequent field 14a of integers becomes 1, 6, 2. The player can eliminate 1 since 6×1=6, leaving a remaining target field 16a of 6, 2, with a final computation 18a performed of 6÷2 producing the target value of 3.

If an arithmetic action results in a two integer sum, difference, product, or quotient, the game allows the integer's digits to be flipped, e.g. 21 can be flipped to 12. For example, FIG. 2 depicts an example game 10b according to one contemplated embodiment of the invention having a selected target value of 3 and a selected quantity of 3 integers for the initial field 12b of integers of 6, 7, 8. Addition, subtraction, multiplication, and division are selected as available arithmetical functions. The player selects 6 and 7 as operated integers and 8 as a carried integer, with 6×7=42. 6 and 7 are therefore eliminated as integers and the subsequent field 14b of integers becomes 4, 2, 8. A flip 20b of the product 42 to 24 is employed to transform the subsequent field 14b into the target field 16b of 2, 4, 8. The resulting target field 16b allows for the combined integer 24 to be divided by the operated integer 8, with a final computation 18b performed of 24÷8 producing the target value of 3.

It will be appreciated that the game can be played with a repeated or duplicate integers in the initial field of integers and assuming the availability of all arithmetical functions of addition, subtraction, multiplication, and division, regardless of whether a flip is employed. It will be further appreciated that similar initial fields of integers can use different solutions for similar target results. For example, FIG. 3 depicts an example game 10c according to one contemplated embodiment of the invention having a selected target value of 3 and a selected quantity of 3 integers for the initial field 12c of integers of 4, 4, 2 similar to the initial field 12a of FIG. 1. In FIG. 3, addition, subtraction, multiplication, and division are assumed as available arithmetical functions. The player again selects 4 and 4 as operated integers and 2 as a carried integer, with 4×4=16. 4 and 4 are therefore eliminated as integers and the subsequent field 14c of integers again becomes 1, 6, 2. The player then selects 1 as a carried integer and selects 6 and 2 selected as operated integers which are multiplied together, resulting in the target field 16c of integers 1, 4. The final computation 18c performed leading to the target value is 4−1=3.

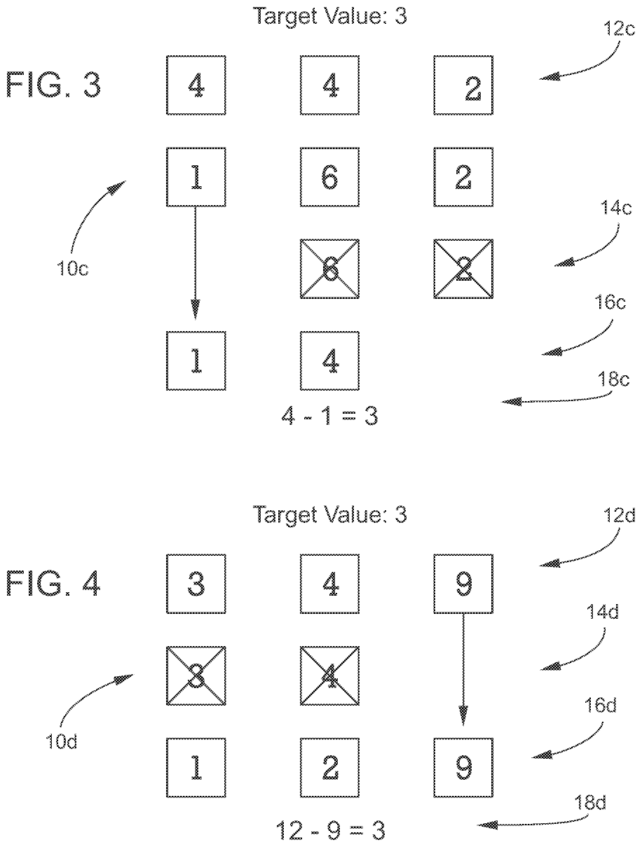

It is possible for a subsequent field of integers to itself become a target field for a final computation to the target value. For example, FIG. 4 depicts an example game 10d according to one contemplated embodiment of the invention having a selected target value of 3 and a selected quantity of 3 integers for the initial field 12d of integers of 3, 4, 9. Addition, subtraction, multiplication, and division are assumed as available arithmetical functions. The player selects 3 and 4 as operated integers and 9 as a carried integer, with 3×4=12. 3 and 4 are therefore eliminated as integers and the subsequent field 14d of integers 1, 2, 9 is also a target field 16d. Combining 1 and 2 into a combined integer of 12 and subtracting the operated integer 9, results in the final computation 18d leading to the target value being 12−9=3.

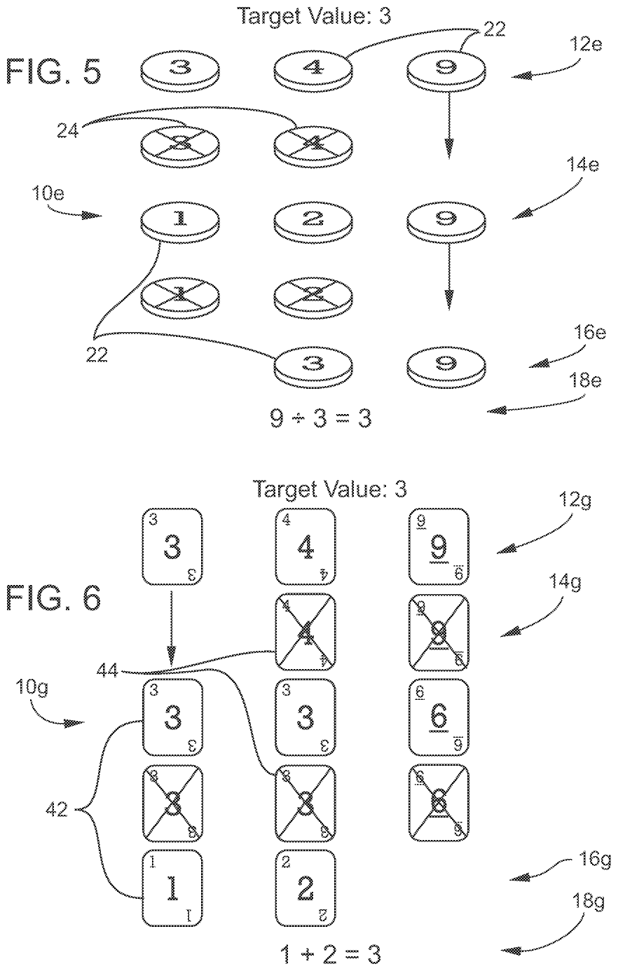

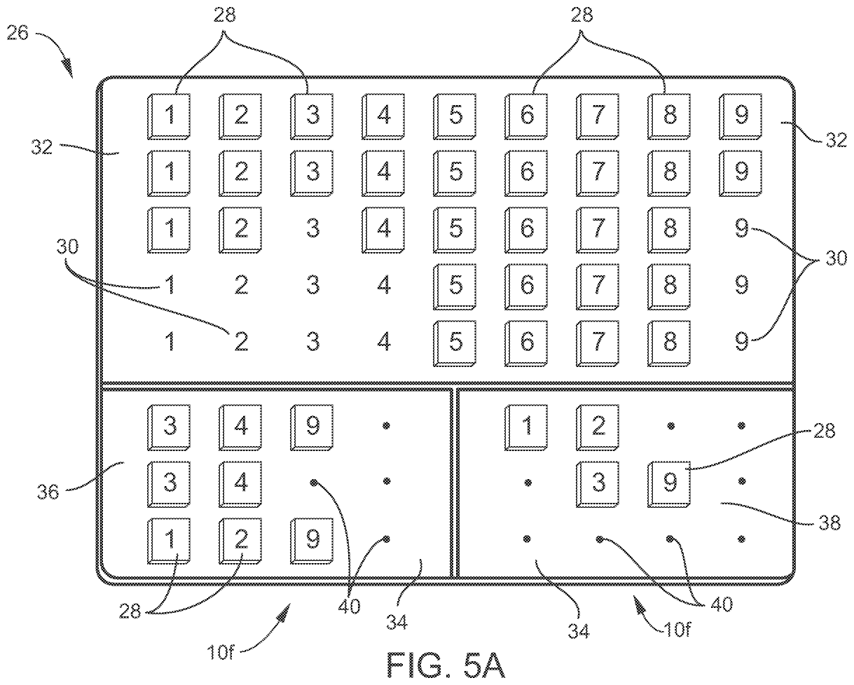

It is contemplated the game can be played in numerous formats and platforms. For example, FIG. 5 depicts a game of the invention played with numbered chips 22 aligned into initial, subsequent, and target fields 12e, 14e, and 16e of integers as the game progresses. For purposes clarity and discussion, some integers eliminated are represented with chips 24 marked with an X, although it will be appreciated in practice such chips 24 would be simply removed from the playing surface of the game 10e after elimination.

The game 10e in FIG. 5 has a selected target value of 3 and a selected quantity of 3 integers for the initial field 12e of integers of 3, 4, 9 with addition, subtraction, multiplication, and division being assumed as available arithmetical functions. The player selects 3 and 4 as operated integers and 9 as a carried integer, with 3×4=12. 3 and 4 are therefore eliminated as integers and the subsequent field 14e of integers becomes 1, 2, 9. The player again selects 9 as a carried integer and selects 1 and 2 as operated integers which are added together, resulting in the target field 16e of integers 3, 9. The final computation 18e performed leading to the target value is 9÷3=3.

Although shown and described as a chip game, it will be appreciated the game of the invention can also be played as a board game. FIG. 5A depicts the game 10e played with numbered playing chips 22 in FIG. 5 as being played as a board game on a playing board 26 with square numbered playing pieces 28. Referring to FIG. 5A, a total of 45 playing pieces 28 includes five playing pieces 28 for each integer 1 through 9. The playing board 26 is divided into a playing piece reservoir 32 and playing area 34. The playing piece reservoir 32 allows the player to store and keep track of unused playing pieces 28, and includes marked vacant reservoir positions 30 to indicate which playing pieces 28 and how many of a particular number have been used. The playing area 34 is itself divided into an initial playing area 36 and a continuation playing area 38 with chip playing positions being indicated in both playing areas 36 and 38 with dots 40. As shown four dots 40 are available per initial, subsequent, and target fields of integers.

As best understood by comparing the game 10f with the equivalent game 10e of FIG. 5, the player of the game 10f in FIG. 5A will begin by utilizing the initial playing area 36 in FIG. 5A until the numbered playing pieces 28 have occupied all available fields of integers, then continue the game into the continuation playing area 38. The player then continues playing in the continuations playing area 38 until all available fields of integers of the continuations playing area 38 are also occupied. The player can then return all playing pieces 28 remaining in the initial playing area 36 to the respective vacant reservoir positions 30 and then resume play. By alternating between the initial and continuation playing areas 36 and 38 in this way, the game can continue to be played indefinitely.

Although the invention has been shown and described incorporating a playing board sized to accommodate a game of the invention utilizing a maximum of 45 playing pieces and sized for a maximum quantity 4 integers for the initial, subsequent and target fields of integers, it will be appreciated that such boards can be adjusted in both size and capacity to accommodate a variety of integer fields, playing pieces, target values, and other variable factors of the disclosed game within the intended scope of the invention.

FIG. 6 depicts a further contemplated embodiment of the invention played as a card game 10g with numbered playing cards 42. For purposes clarity and discussion, some integers eliminated are represented with cards 44 marked with an X, although it will be appreciated in practice such cards 44 would be simply removed from the playing surface of the game 10g after elimination. FIG. 6 also represents a variation in the manner in which a player might play the game represented in FIG. 5 using the initial field of integers 3, 4, 9. Like FIG. 5, the game 10g in FIG. 6 has a selected target value of 3 and a selected quantity of 3 integers for the initial field 12g of integers of 3, 4, 9 with addition, subtraction, multiplication, and division being assumed as available arithmetical functions. However, in this example, the player selects 4 and 9 as operated integers and 3 as a carried integer, with 4×9=36. 4 and 9 are therefore eliminated as integers and the subsequent field 14g of integers becomes 3, 3, 6. The player then selects 3 as an operated integer and 3 and 6 as combined integer 36, with 36÷3=12, resulting in a target field 16g of 1, 2. The final computation 18g leading to the target value is 1+2=3.

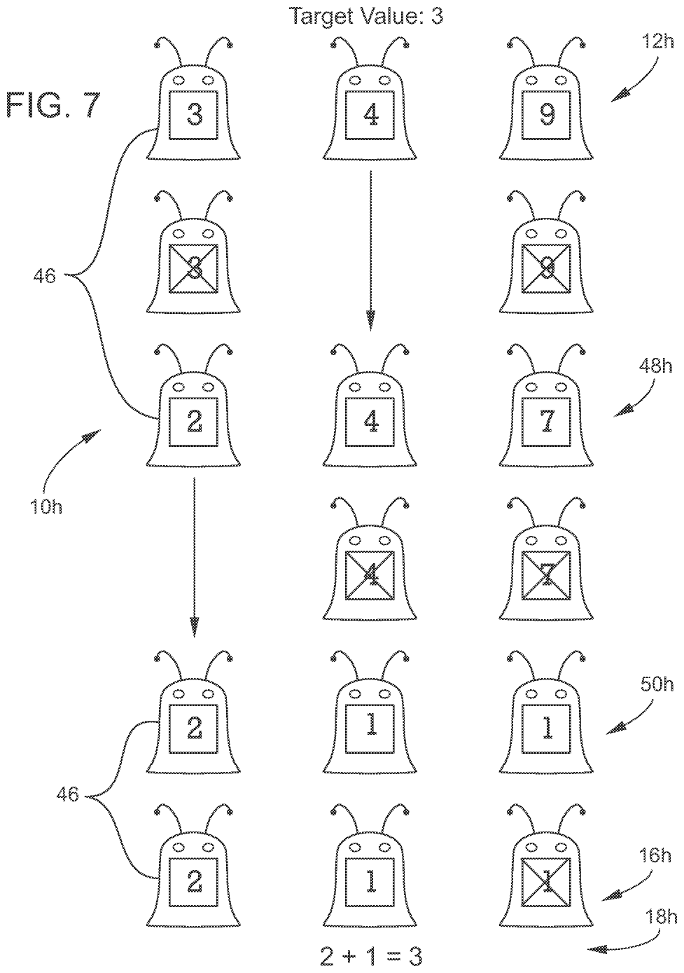

It will be further appreciated the invention can also be played on several other platforms such as in computer apps, electronic tablets, cell phones, gaming consoles, and other electronic and virtual environments. For example, FIG. 7 depicts a contemplated game 10h of the invention being played in an electronic virtual environment using avatars 46. FIG. 7 also represents a variation in the manner in which a player might play the games represented in FIGS. 5 & 6 using the initial field of integers 3, 4, 9. Like FIGS. 5 & 6 , the game 10h in FIG. 7 has a selected target value of 3 and a selected quantity of 3 integers for the initial field 12h of integers of 3, 4, 9 with addition, subtraction, multiplication, and division being assumed as available arithmetical functions. However, in this example, the player selects 3 and 9 as operated integers and 4 as a carried integer, with 3×9=27. 3 and 9 are therefore eliminated as integers and the first subsequent field 48h of integers becomes 2, 4, 7. The player then selects 2 a carried integer and 4 and 7 as operated integer, 4÷7=11, resulting in a second subsequent field of 50h of integers being 2, 1, 1. Multiplying 1×1 creates a target field 16h of 2, 1. The final computation 18h leading to the target value is 2+1=3.

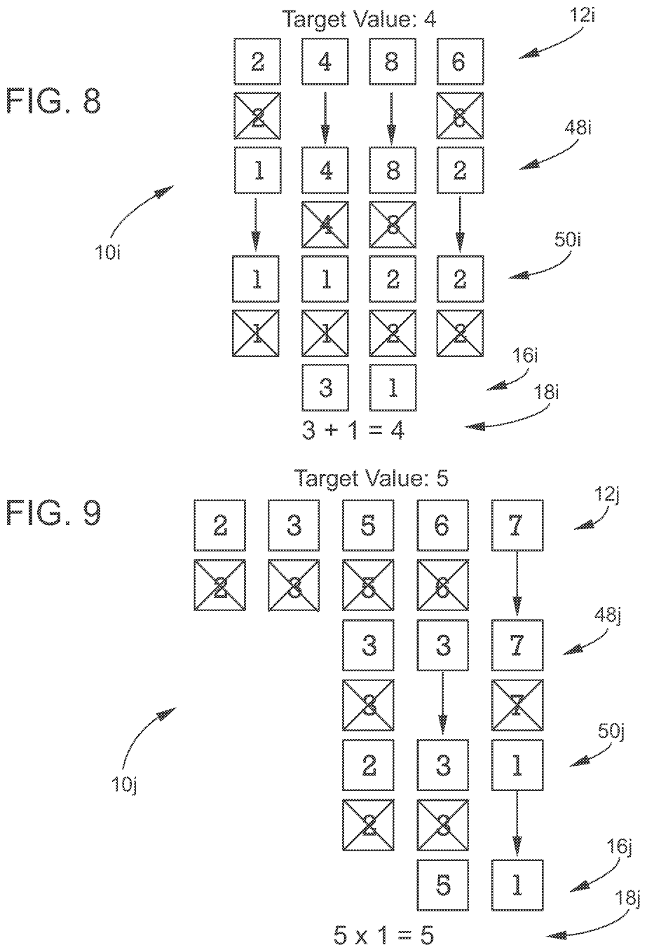

Although the invention has been shown and described as having target values of 3 and fields of integers having quantities of 3 integers, it will be appreciated that the game can be played with larger target values and quantities of integers in the initial fields. For example, FIG. 8 depicts a game 10i according to one contemplated embodiment of the invention having a selected target value of 4 and a selected quantity of 4 integers for the initial field 12i of integers of 2, 4, 8, 6. Addition, subtraction, multiplication, and division are assumed as available arithmetical functions. The player selects 2 and 6 as operated integers and 4 and 8 as carried integers, with 2×6=12. 2 and 6 are therefore eliminated as integers and the first subsequent field 48i of integers is 1, 4, 8, 2. The player then selects 1 and 2 as carried integers and 4 and 8 as operated integers, with 4+8=12 and the second subsequent field 50i of integers being 1, 1, 2, 2. Selecting all of the integers in the second subsequent field 50i to be operated integers, the player performs both addition and subtraction, with 1+2=3 and 2−1=1, leaving a target field 16i of 3, 1. The final computation 18i leading to the target value is 3+1=4.

As another example, FIG. 9 depicts a game 10j according to one contemplated embodiment of the invention having a selected target value of 5 and a selected quantity of 5 integers for the initial field 12j of integers of 2, 3, 5, 6, 7. Addition, subtraction, multiplication, and division are assumed as available arithmetical functions. The player selects 2, 3, 5, 6 as operated integers and 7 as a carried integer, with 5−2=3 and 6−3=3. 2, 3, 5, and 6 are therefore eliminated as integers and the first subsequent field 48j of integers is 3, 3, 7. The player then selects 3 as a carried integer and 3 and 7 as operated integers, with 3×7=21 and the second subsequent field 50j of integers being 2, 3, 1. Selecting 2 and 3 as operated integers and 1 as a carried integer, 2+3=5, leaving a target field 16j of 5, 1. The final computation 18j leading to the target value is 5×1=5.

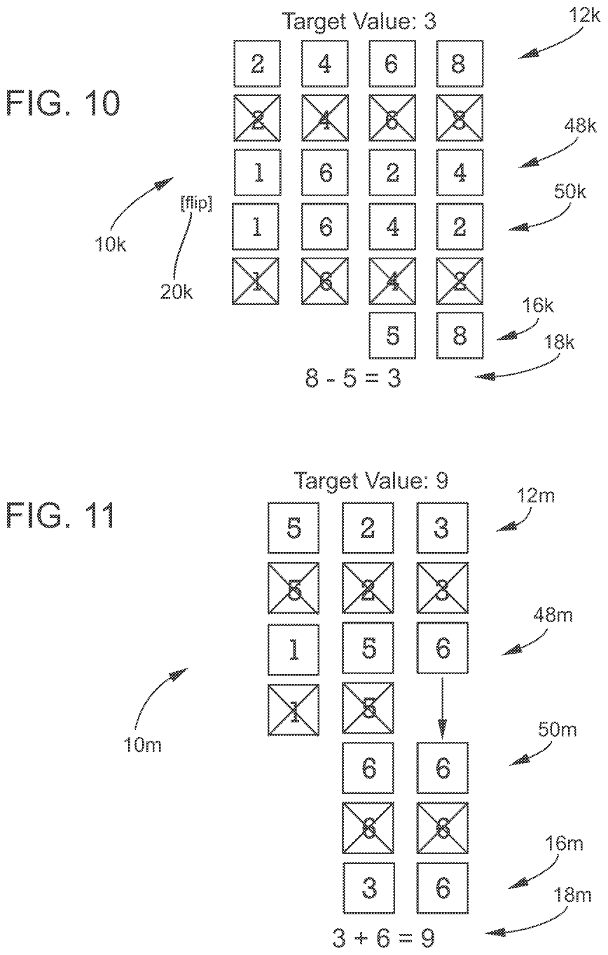

It will be further appreciated that the game can be played having target value that differs from a selected quantity of integers for the initial field. For example, FIG. 10 depicts a game 10k according to one contemplated embodiment of the invention having a selected target value of 3 and a selected quantity of 4 integers for the initial field 12k of integers of 2, 4, 6, 8. Addition, subtraction, multiplication, and division are assumed as available arithmetical functions. The player selects all of 2, 4, 6, 8 as operated integers, with 2×8=16 and 4×6=24, leaving a subsequent field of integers 48k of 1, 6, 2, 4. A flip 20k of the product 24 to 42 is employed to create the second subsequent field 50k of 1, 6, 4, 2. The player then selects all of 1, 6, 4, 2 as operated integers with 6−1=5 and 4×2=8. The resulting target field 16k is therefore 5, 8. The final computation 18k leading to the target value is 8−5=3.

It is further contemplated the game can be played with a target value that is greater than the selected quantity of integers for the initial field. For example, FIG. 11 depicts a game 10m according to one contemplated embodiment of the invention having a selected target value of 9 and a selected quantity of 3 integers for the initial field 12m of integers of 5, 2, 3. Addition, subtraction, multiplication, and division are assumed as available arithmetical functions. The player selects 5 and 2 as combined integers and selects 3 as an operated integer with 52×3=156, leading to a first subsequent field 48m of 1, 5, 6. The player then selects 1 and 5 as operated integers and 6 as a carried integer, with 1+5=6 and a resulting second subsequent field 50m of 6, 6. Selecting 6 and 6 both as operated integers, 6×6=36, leading to a target field 16m of integers 3, 6. The final computation 18m leading to the target value is 3+6=9.

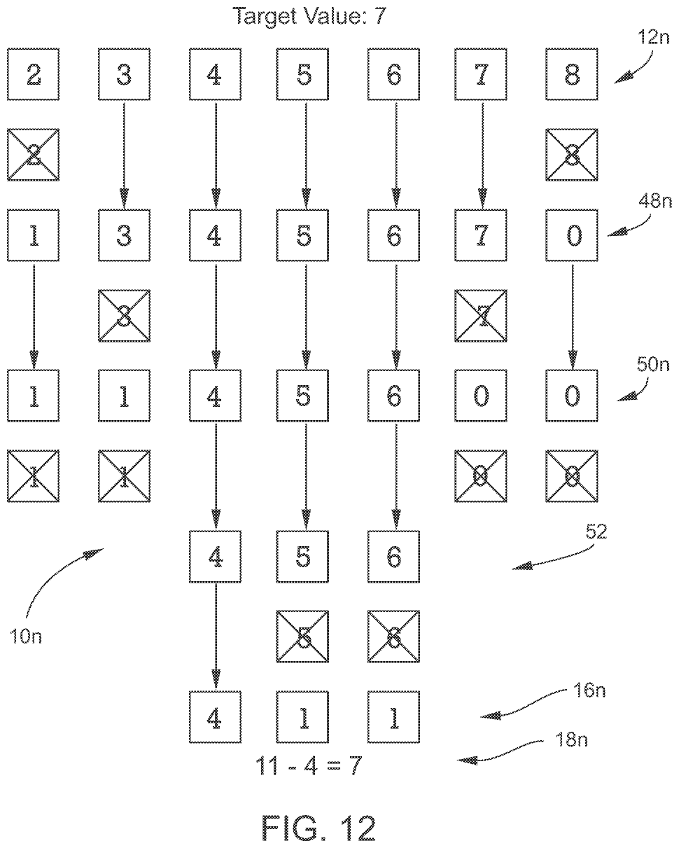

Games having both larger target values and larger selected quantities of integers for the initial field are also contemplated. For example, FIG. 12 depicts a game 10n of the invention having a selected target value of 7 and a selected quantity of 7 integers for the initial field 12n of integers of 2, 3, 4, 5, 6, 7, 8. Addition, subtraction, multiplication, and division are assumed as available arithmetical functions. The player selects 2 and 8 as combined integers and selects 3, 4, 5, 6, 7 as carried integers with 2+8=10, leading to a first subsequent field 48n of 1, 3, 4, 5, 6, 7, 0. The player then selects 1, 4, 5, 6, 0 as carried integers and 3 and 7 as operated integers, with 3+7=10 and a resulting second subsequent field 50n of 1, 1, 4, 5, 6, 0, 0. Selecting 1, 1, 0, 0 as operated integers and 4, 5, 6 as carried integers, with 1×0=0 and 1×0=0, a third subsequent field 52 of integers is 4, 5, 6. Selecting 4 as a carried integer and 5 and 6 as operated integers, with 5+6=11, a resulting target field 16m of integers is 4, 1, 1. The final computation 18n leading to the target value is 11−4=7.

Although the invention has been shown and described as having target values of integers between 1 and 9, it will be appreciated that target values above 10 are also possible and are within the contemplated scope of the invention.

Those skilled in the art will also realize that this invention is capable of other embodiments different from those shown and described. It will be appreciated that the detail of the structure of the disclosed games, apparatuses, and methodologies can be changed in various ways without departing from the invention itself. Accordingly, the drawings and Detailed Description of the Invention are to be regarded as including such equivalents as do not depart from the spirit and scope of the invention.

1. An arithmetic game comprising:
selecting a set of available arithmetical functions, said set of available arithmetical functions including at least one of addition, subtraction, multiplication, and division;
selecting a target value that is an integer;
selecting a quantity of initial integers and generating an initial integer field having said quantity of initial integers, all said initial integers being single digit integers;
generating at least one subsequent field of integers by:
selecting and combining into at least one combined integer at least two integers from said initial integer field or from another subsequent field of integers;
selecting single digit carried integers from said initial integer field or from said another subsequent field of integers;
selecting operated integers that are all single digit integers from said initial integer field or from said another subsequent field of integers that have not been selected to be combined into at least one said combined integer and have not been selected to be said carried integers; and
using at least one function from said available set of available arithmetical functions with at least one said combined integer or at least one said operated integer to add to, subtract from, multiply by, or divide by at least one other said combined integer or at least one other said operated integer to produce at least one sum, difference, product, or quotient that is a calculated integer; said subsequent field of integers being all the digits of all said carried integers and all the digits of all said calculated integers; and
generating a target value by:
selecting one said subsequent field of integers to be a target field, said target field having no carried integers;
selecting which of said integers of said target field are to be combined into combined integers and selecting which of said integers of said target field are to be operated integers; and
using at least one function from said available set of available arithmetical functions with at least one said combined integer from said target field or at least one said operated integer from said target field to add to, subtract from, multiply by, or divide by at least one other said combined integer from said target field or at least one other said operated integer from said target field to produce at least one sum, difference, product, or quotient that is said target value.

2. The arithmetic game of claim 1 further comprising generating multiple subsequent fields of integers.

3. The arithmetic game of claim 1 wherein said quantity of initial integers is 3.

4. The arithmetic game of claim 1 wherein said quantity of initial integers is greater than 3.

5. The arithmetic game of claim 1 wherein said target value is 3.

6. The arithmetic game of claim 1 wherein said quantity of initial integers is the same as said target value.

7. The arithmetic game of claim 1 wherein said quantity of initial integers is greater than said target value.

8. The arithmetic game of claim 1 wherein said quantity of initial integers is less than said target value.

9. The arithmetic game of claim 1 wherein said initial integers are generated randomly.

10. The arithmetic game of claim 1 wherein said initial integers are generated using a random number generator.

11. The arithmetic game of claim 1 wherein said initial integers are generated randomly using dice.

12. The arithmetic game of claim 1 wherein said initial integers are generated randomly using a spin wheel.

13. The arithmetic game of claim 1 wherein said initial integers are generated randomly by drawing numbers.

14. The arithmetic game of claim 1 wherein said initial integers are purposefully generated.

15. The arithmetic game of claim 1 wherein said game is played by a single player.

16. The arithmetic game of claim 1 wherein multiple players compete by attempting to create the largest number of potential solutions for generating said target value.

17. The arithmetic game of claim 1 wherein multiple players compete by attempting to exhaust potential solutions for generating said target value.

18. The arithmetic game of claim 1 wherein teams of individuals compete by attempting to exhaust potential solutions for generating said target value.

19. The arithmetic game of claim 1 wherein players compete by attempting to create the most unique solutions for generating said target value.

20. The arithmetic game of claim 1 wherein said game is played with multiple players, each player attempts to generate said target value in the shortest time interval.

21. The arithmetic game of claim 1 wherein said game is played with multiple players, each player attempting to generate said target value using the smallest number of subsequent fields of integers.

22. The arithmetic game of claim 1 wherein said game is played with multiple players, each player attempting to generate said target value using the smallest number of subsequent fields of integers during a predetermined time interval.

23. The arithmetic game of claim 1 wherein said game is played on a computer.

24. The arithmetic game of claim 1 wherein said game is played as a board game.

25. The arithmetic game of claim 1 wherein said game is played with game chips.

26. The arithmetic game of claim 1 wherein said game is played with numbered cards.

27. An arithmetic game comprising:
selecting a set of available arithmetical functions, said set of available arithmetical functions including at least one of addition, subtraction, multiplication, and division;
selecting a target value that is an integer between 1 and 9;
selecting a quantity of initial integers and generating an initial integer field having said quantity of initial integers, all said initial integers being single digit integers;
generating at least one subsequent field of integers by:
selecting and combining into at least one combined integer at least two integers from said initial integer field or from another subsequent field of integers;
selecting single digit carried integers from said initial integer field or from said another subsequent field of integers;
selecting operated integers that are all single digit integers from said initial integer field or from said another subsequent field of integers that have not been selected to be combined into at least one said combined integer and have not been selected to be said carried integers; and
using at least one function from said available set of available arithmetical functions with at least one said combined integer or at least one said operated integer to add to, subtract from, multiply by, or divide by at least one other said combined integer or at least one other said operated integer to produce at least one sum, difference, product, or quotient that is a calculated integer; said subsequent field of integers being all the digits of all said carried integers and all the digits of all said calculated integers; and
generating a target value by:
selecting one said subsequent field of integers to be a target field, said target field having no carried integers;
selecting which of said integers of said target field are to be combined into combined integers and selecting which of said integers of said target field are to be operated integers; and
using at least one function from said available set of available arithmetical functions with at least one said combined integer from said target field or at least one said operated integer from said target field to add to, subtract from, multiply by, or divide by at least one other said combined integer from said target field or at least one other said operated integer from said target field to produce at least one sum, difference, product, or quotient that is said target value.

28. The arithmetic game of claim 27 further comprising generating multiple subsequent fields of integers.

29. The arithmetic game of claim 27 wherein said quantity of initial integers is 3.

30. The arithmetic game of claim 27 wherein said quantity of initial integers is greater than 3.

31. The arithmetic game of claim 27 wherein said target value is 3.

32. The arithmetic game of claim 27 wherein said quantity of initial integers is the same as said target value.

33. The arithmetic game of claim 27 wherein said quantity of initial integers is greater than said target value.

34. The arithmetic game of claim 27 wherein said quantity of initial integers is less than said target value.

35. The arithmetic game of claim 27 wherein said initial integers are generated randomly.

36. The arithmetic game of claim 27 wherein said initial integers are generated using a random number generator.

37. The arithmetic game of claim 27 wherein said initial integers are generated randomly using dice.

38. The arithmetic game of claim 27 wherein said initial integers are generated randomly using a spin wheel.

39. The arithmetic game of claim 27 wherein said initial integers are generated randomly by drawing numbers.

40. The arithmetic game of claim 27 wherein said initial integers are purposefully generated.

41. The arithmetic game of claim 27 wherein said game is played by a single player.

42. The arithmetic game of claim 27 wherein multiple players compete by attempting to create the largest number of potential solutions for generating said target value.

43. The arithmetic game of claim 27 wherein multiple players compete by attempting to exhaust potential solutions for generating said target value.

44. The arithmetic game of claim 27 wherein teams of individuals compete by attempting to exhaust potential solutions for generating said target value.

45. The arithmetic game of claim 27 wherein players compete by attempting to create the most unique solutions for generating said target value.

46. The arithmetic game of claim 27 wherein said game is played with multiple players, each player attempts to generate said target value in the shortest time interval.

47. The arithmetic game of claim 27 wherein said game is played with multiple players, each player attempting to generate said target value using the smallest number of subsequent fields of integers.

48. The arithmetic game of claim 27 wherein said game is played with multiple players, each player attempting to generate said target value using the smallest number of subsequent fields of integers during a predetermined time interval.

49. The arithmetic game of claim 27 wherein said game is played on a computer.

50. The arithmetic game of claim 27 wherein said game is played as a board game.

51. The arithmetic game of claim 27 wherein said game is played with game chips.

52. The arithmetic game of claim 27 wherein said game is played with numbered cards.

53. An arithmetic game comprising:
selecting a set of available arithmetical functions, said set of available arithmetical functions including at least one of addition, subtraction, multiplication, and division;
selecting a target value that is an integer between 1 and 9;
selecting a quantity of initial integers and randomly generating an initial integer field having said quantity of initial integers, all said initial integers being single digit integers;
generating multiple subsequent fields of integers by:
selecting and combining into at least one combined integer at least two integers from said initial integer field or from another subsequent field of integers;
selecting single digit carried integers from said initial integer field or from said another subsequent field of integers;
selecting operated integers that are all single digit integers from said initial integer field or from said another subsequent field of integers that have not been selected to be combined into at least one said combined integer and have not been selected to be said carried integers; and
using at least one function from said available set of available arithmetical functions with at least one said combined integer or at least one said operated integer to add to, subtract from, multiply by, or divide by at least one other said combined integer or at least one other said operated integer to produce at least one sum, difference, product, or quotient that is a calculated integer; said subsequent field of integers being all the digits of all said carried integers and all the digits of all said calculated integers; and
generating a target value by:
selecting one said subsequent field of integers to be a target field, said target field having no carried integers;
selecting which of said integers of said target field are to be combined into combined integers and selecting which of said integers of said target field are to be operated integers; and
using at least one function from said available set of available arithmetical functions with at least one said combined integer from said target field or at least one said operated integer from said target field to add to, subtract from, multiply by, or divide by at least one other said combined integer from said target field or at least one other said operated integer from said target field to produce at least one sum, difference, product, or quotient that is said target value.

54. The arithmetic game of claim 53 wherein said quantity of initial integers is 3.

55. The arithmetic game of claim 53 wherein said quantity of initial integers is greater than 3.

56. The arithmetic game of claim 53 wherein said target value is 3.

57. The arithmetic game of claim 53 wherein said quantity of initial integers is the same as said target value.

58. The arithmetic game of claim 53 wherein said quantity of initial integers is greater than said target value.

59. The arithmetic game of claim 53 wherein said quantity of initial integers is less than said target value.

60. The arithmetic game of claim 53 wherein said initial integers are generated using a random number generator.

61. The arithmetic game of claim 53 wherein said initial integers are generated randomly using dice.

62. The arithmetic game of claim 53 wherein said initial integers are generated randomly using a spin wheel.

63. The arithmetic game of claim 53 wherein said initial integers are generated randomly by drawing numbers.

64. The arithmetic game of claim 53 wherein said game is played by a single player.

65. The arithmetic game of claim 53 wherein multiple players compete by attempting to create the largest number of potential solutions for generating said target value.

66. The arithmetic game of claim 53 wherein multiple players compete by attempting to exhaust potential solutions for generating said target value.

67. The arithmetic game of claim 53 wherein teams of individuals compete by attempting to exhaust potential solutions for generating said target value.

68. The arithmetic game of claim 53 wherein players compete by attempting to create the most unique solutions for generating said target value.

69. The arithmetic game of claim 53 wherein said game is played with multiple players, each player attempts to generate said target value in the shortest time interval.

70. The arithmetic game of claim 53 wherein said game is played with multiple players, each player attempting to generate said target value using the smallest number of subsequent fields of integers.

71. The arithmetic game of claim 53 wherein said game is played with multiple players, each player attempting to generate said target value using the smallest number of subsequent fields of integers during a predetermined time interval.

72. The arithmetic game of claim 53 wherein said game is played on a computer.

73. The arithmetic game of claim 53 wherein said game is played as a board game.

74. The arithmetic game of claim 53 wherein said game is played with game chips.

75. The arithmetic game of claim 53 wherein said game is played with numbered cards.

76. An arithmetic game comprising:
selecting a set of available arithmetical functions, said set of available arithmetical functions including at least one of addition, subtraction, multiplication, and division;
selecting a target value of 3;
selecting three initial integers and generating an initial integer field having three initial integers, all said initial integers being single digit integers;
generating at least one subsequent field of integers by:
selecting and combining into at least one combined integer at least two integers from said initial integer field or from another subsequent field of integers;
selecting single digit carried integers from said initial integer field or from said another subsequent field of integers;
selecting operated integers that are all single digit integers from said initial integer field or from said another subsequent field of integers that have not been selected to be combined into at least one said combined integer and have not been selected to be said carried integers; and
using at least one function from said available set of available arithmetical functions with at least one said combined integer or at least one said operated integer to add to, subtract from, multiply by, or divide by at least one other said combined integer or at least one other said operated integer to produce at least one sum, difference, product, or quotient that is a calculated integer; said subsequent field of integers being all the digits of all said carried integers and all the digits of all said calculated integers; and
generating a target value by:
selecting one said subsequent field of integers to be a target field, said target field having no carried integers;
selecting which of said integers of said target field are to be combined into combined integers and selecting which of said integers of said target field are to be operated integers; and
using at least one function from said available set of available arithmetical functions with at least one said combined integer from said target field or at least one said operated integer from said target field to add to, subtract from, multiply by, or divide by at least one other said combined integer from said target field or at least one other said operated integer from said target field to produce at least one sum, difference, product, or quotient of 3.

77. The arithmetic game of claim 76 further comprising generating multiple subsequent fields of integers.

78. The arithmetic game of claim 76 wherein said initial integers are generated randomly.

79. The arithmetic game of claim 76 wherein said initial integers are generated using a random number generator.

80. The arithmetic game of claim 76 wherein said initial integers are generated randomly using dice.

81. The arithmetic game of claim 76 wherein said initial integers are generated randomly using a spin wheel.

82. The arithmetic game of claim 76 wherein said initial integers are generated randomly by drawing numbers.

83. The arithmetic game of claim 76 wherein said initial integers are purposefully generated.

84. The arithmetic game of claim 76 wherein said game is played by a single player.

85. The arithmetic game of claim 76 wherein multiple players compete by attempting to create the largest number of potential solutions for generating said target value.

86. The arithmetic game of claim 76 wherein multiple players compete by attempting to exhaust potential solutions for generating said target value.

87. The arithmetic game of claim 76 wherein teams of individuals compete by attempting to exhaust potential solutions for generating said target value.

88. The arithmetic game of claim 76 wherein players compete by attempting to create the most unique solutions for generating said target value.

89. The arithmetic game of claim 76 wherein said game is played with multiple players, each player attempts to generate said target value in the shortest time interval.

90. The arithmetic game of claim 76 wherein said game is played with multiple players, each player attempting to generate said target value using the smallest number of subsequent fields of integers.

91. The arithmetic game of claim 76 wherein said game is played with multiple players, each player attempting to generate said target value using the smallest number of subsequent fields of integers during a predetermined time interval.

92. The arithmetic game of claim 76 wherein said game is played on a computer.

93. The arithmetic game of claim 76 wherein said game is played as a board game.

94. The arithmetic game of claim 76 wherein said game is played with game chips.

95. The arithmetic game of claim 76 wherein said game is played with numbered cards.
